(19) United States
(12) Patent Application Publication
(10) Pub. No.: US 2026/0101388 A1
(43) Pub. Date: Apr. 9, 2026

(54) METHOD AND APPARATUS FOR IAB NODE INTEGRATION

(71) Applicant: Lenovo (Beijing) Limited, Beijing (CN)

(72) Inventors: Yibin Zhuo, Shanghai (CN); Mingzeng Dai, Shanghai (CN); Lianhai Wu, Beijing (CN); Le Yan, Shanghai (CN)

(73) Assignee: Lenovo (Beijing) Limited, Beijing (CN)

(21) Appl. No.: 19/112,297

(22) PCT Filed: Sep. 28, 2022
(86) PCT No.: PCT/CN2022/122184

§ 371 Date: Mar. 17, 2025

(51) Int. Cl. H04W 76/10; H04W 92/20

(52) U.S. Cl. CPC H04W 76/10; H04W 92/20

(57) ABSTRACT

Embodiments of the present disclosure relate to method and apparatus for IAB node integration. According to some embodiments of the disclosure, a first centralized unit (CU) may: establish a radio resource control (RRC) connection with a network node; and transmit, to a second CU, information associated with the network node to facilitate an F1 connection setup between the network node and the second CU.

### TECHNICAL FIELD

Embodiments of the present disclosure generally relate to communication technology, and more particularly to integrated access and backhaul (IAB) node integration.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for facilitating communications in the IAB network.

### SUMMARY

Some embodiments of the present disclosure provide a first centralized unit (CU). The first CU may include: a processor configured to establish a radio resource control (RRC) connection with a network node; and a transceiver coupled to the processor and configured to transmit, to a second CU, information associated with the network node to facilitate an F1 connection setup between the network node and the second CU.

In some embodiments of the present disclosure, the information associated with the network node may be transmitted to the second CU via an Xn interface between the first CU and the second CU. In some embodiments of the present disclosure, the information associated with the network node may be transmitted to the second CU via a core network entity.

In some embodiments of the present disclosure, the transceiver may be further configured to: receive, from the second CU, an indication indicating that the second CU is a mobile CU specific for a mobile network node; or receive, from a core network entity, an identifier of the second CU, wherein the second CU is a mobile CU specific for a mobile network node.

In some embodiments of the present disclosure, the indication may be included in one of the following message from the second CU to the first CU: an Xn setup response message; an Xn setup request message; a next generation-radio access network (NG-RAN) node configuration update acknowledge message; and an NG-RAN node configuration update message.

In some embodiments of the present disclosure, the second CU may be a donor CU or a mobile CU.

Some embodiments of the present disclosure provide a network node. The network node may include a transceiver; and a processor coupled to the transceiver. The processor may be configured to: establish a radio resource control (RRC) connection with a first centralized unit (CU); and set up an F1 connection with a second CU during an initial access of the network node to a network or during a migration of the network node from the first CU to the second CU.

Some embodiments of the present disclosure provide a second centralized unit (CU). The second CU may include: a transceiver configured to receive, from a first CU, information associated with a network node, wherein the network node has a radio resource control (RRC) connection with the first CU; and a processor coupled to the transceiver and configured to set up an F1 connection with the network node based at least on the information associated with the network node.

In some embodiments of the present disclosure, the information associated with the network node may include at least one of: internet protocol (IP) header information of a downlink (DL) message associated with the F1 connection setup to the network node; a backhaul adaptation protocol (BAP) address of the network node; a distributed unit (DU) ID of the network node; or a global ID of the first CU. In some embodiments of the present disclosure, the IP header information of the DL message associated with the F1 connection setup to the network node may include at least one of: a differentiated services code point (DSCP) of the DL message; an IPv6 flow label of the DL message; or an IP address or a transport network layer (TNL) address of the network node.

In some embodiments of the present disclosure, the information associated with the network node may be receive from the first CU via an Xn interface between the first CU and the second CU. In some embodiments of the present disclosure, the information associated with the network node may be receive from the first CU via a core network entity.

In some embodiments of the present disclosure, the transceiver may be further configured to transmit, to the first CU or a core network entity, an indication indicating that the second CU is a mobile CU specific for a mobile network node. In some embodiments of the present disclosure, the indication may be included in one of the following message: an Xn setup response message from the second CU to the first CU; an Xn setup request message from the second CU to the first CU; a next generation-radio access network (NG-RAN) node configuration update acknowledge message from the second CU to the first CU; an NG-RAN node configuration update message from the second CU to the first CU; and an NG setup request message from the second CU to the core network entity.

In some embodiments of the present disclosure, the transceiver may be further configured to receive, from the network node, an F1 setup request message, wherein the F1 setup request message may include a global ID of the network node. In some embodiments of the present disclosure, the global ID of the network node may include at least one of the following: a global ID of the first CU and a backhaul adaptation protocol (BAP) address of the network node; a global ID of the first CU and a distributed unit (DU) ID of the network node; or an internet protocol (IP) address of the network node.

In some embodiments of the present disclosure, the second CU may be a donor CU or a mobile CU.

Some embodiments of the present disclosure provide a method performed by a first CU. The method may include: establishing a radio resource control (RRC) connection with a network node; and transmitting, to a second CU, information associated with the network node to facilitate an F1 connection setup between the network node and the second CU.

Some embodiments of the present disclosure provide a method performed by a network node. The method may include: establishing a radio resource control (RRC) connection with a first centralized unit (CU); and setting up an F1 connection with a second CU during an initial access of the network node to a network or during a migration of the network node from the first CU to the second CU.

Some embodiments of the present disclosure provide a method performed by a second CU. The method may include: receiving, from a first CU, information associated with a network node, wherein the network node has a radio resource control (RRC) connection with the first CU; and setting up an F1 connection with the network node based at least on the information associated with the network node.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate example block diagrams of a protocol stack for an IAB network in accordance with some embodiments of the present disclosure;

FIGS. 4 and 5 illustrate schematic diagrams of wireless communication system in accordance with some embodiments of the present disclosure;

FIGS. 6-15 illustrate flow charts of exemplary procedures of wireless communications in accordance with some embodiments of the present disclosure; and

FIG. 16 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, a 1000-time capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. In addition, the deployment of optical fiber may be difficult and costly for these small stations. Therefore, an economical and convenient backhaul scheme is needed. Integrated access and backhaul (IAB) technology, whose access link(s) and backhaul link(s) may both use wireless transmission solutions to avoid fiber deployment, provides ideas for solving the above problems.

In an IAB network, a wireless network node such as a relay node (RN) or an IAB node or a wireless backhaul node/device can provide wireless access services for UEs. For example, a UE can connect to an IAB donor relayed by one or more IAB nodes. The IAB donor may also be called a donor node or a donor base station (e.g., DgNB, Donor gNodeB). In addition, the wireless link between an IAB donor and an IAB node, or the wireless link between different IAB nodes can be referred to as a “backhaul link.” The wireless network node in an IAB network may be stationary or mobile.

An IAB node may include an IAB mobile terminal (MT) part and an IAB distributed unit (DU) part. When an IAB node connects to its parent node (which may be another IAB node or an IAB donor), it can be regarded as a UE, i.e., the role of an MT. When an IAB node provides service to its child node (which may be another IAB node or a UE), it can be regarded as a network device, i.e., the role of a DU.

An IAB donor can be an access network element with a complete base station function, or an access network element with a separate form of a centralized unit (CU) and a distributed unit (DU). The IAB donor may be connected to the core network (for example, connected to the 5G core (5GC) network), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the limited coverage of a high frequency band, and in order to ensure coverage performance of the network, multi-hop networking may be adopted in an IAB network. Taking into account the requirements of service transmission reliability, IAB nodes can support dual connectivity (DC) or multi-connectivity to improve the transmission reliability, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

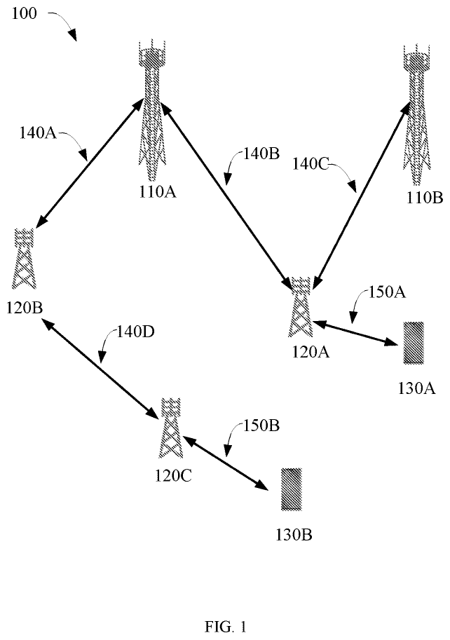

FIG. 1 illustrates a schematic diagram of wireless communication system 100 in accordance with some embodiments of the present disclosure.

As shown in FIG. 1, the wireless communication system 100 may include some base stations (e.g., IAB donor 110A and IAB donor 110B), some IAB nodes (e.g., IAB node 120A, IAB node 120B, and IAB node 120C), and some UEs (e.g., UE 130A and UE 130B). Although a specific number of UEs, IAB nodes, and IAB donors is depicted in FIG. 1, it is contemplated that any number of UEs, IAB nodes, and IAB donors may be included in the wireless communication system 100.

Each of IAB donor 110A, IAB donor 110B, IAB node 120A, IAB node 120B, and IAB node 120C may be directly connected to one or more IAB node(s) in accordance with some other embodiments of the present disclosure. Each of IAB donor 110A, IAB donor 110B, IAB node 120A, IAB node 120B, and IAB node 120C may be directly connected to one or more UEs in accordance with some other embodiments of the present disclosure.

UE 130A and UE 130B may be any type of device configured to operate and/or communicate in a wireless environment. For example, UE 130A and UE 130B may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130A and UE 130B may include a portable wireless communication device, a smart phone, a cellular telephone, a flip phone, a device having a subscriber identity module, a personal computer, a selective call receiver, or any other device that is capable of transmission and receiving communication signals on a wireless network. In some embodiments of the present disclosure, UE 130A and UE 130B may include wearable devices, such as smart watches, fitness bands, optical head-mounted displays, internet-of-things (IoT) devices, or the like. Moreover, UE 130A and UE 130B may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donors 110A and 110B may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donors 110A and 110B may transmit data using an orthogonal frequency division multiple (OFDM) modulation scheme on the DL. UE 130A and UE 130B may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120A can be directly connected to IAB donors 110A and 110B, and IAB node 120B can be directly connected to IAB donor 110A. IAB donors 110A and 110B are parent nodes of IAB node 120A, and IAB donor 110A is a parent node of IAB node 120B. In other words, IAB nodes 120A and 120B are child IAB nodes of IAB donor 110A, and IAB node 120A is also a child IAB node of IAB donor 110B. IAB node 120C can reach IAB donor 110A by hopping through IAB node 120B. IAB node 120B is a parent IAB node of IAB node 120C. In other words, IAB node 120C is a child IAB node of IAB node 120B.

In some other embodiments of the present disclosure, an IAB node may be connected to IAB node 120C so it can reach IAB donor 110A by hopping through IAB node 120C and IAB node 120B. This IAB node and IAB node 120C may be referred to as the descendant IAB nodes of IAB node 120B.

UEs 130A and 130B can be connected to IAB nodes 120A and 120C, respectively. IAB nodes 120A and 120C may therefore be referred to as an access IAB node. Uplink (UL) packets (e.g., data or signaling) from UE 130A or UE 130B can be transmitted to an IAB donor (e.g., IAB donor 110A or 110B) via one or more IAB nodes, and then transmitted by the IAB donor to a mobile gateway device (such as the user plane function (UPF) in the 5GC). Downlink (DL) packets (e.g., data or signaling) can be transmitted from the IAB donor (e.g., IAB donor 110A or 110B) after being received by the gateway device, and then transmitted to UE 130A or 130B through one or more IAB nodes.

For example, referring to FIG. 1, UE 130A may transmit UL data to IAB donor 110A or 110B or receive DL data therefrom via IAB node 120A. UE 130B may transmit UL data to IAB donor 110A or receive DL data therefrom via IAB node 120C and IAB Node 120B.

In an IAB deployment such as the wireless communication system 100, the radio link between an IAB donor (e.g., IAB donor 110A or 110B in FIG. 1) and an IAB node or between two IAB nodes may be referred to as a backhaul link (BL). The radio link between an IAB donor (e.g., IAB donor 110A or 110B in FIG. 1) and a UE or between an IAB node and a UE may be referred to as an access link (AL). For example, in FIG. 1, radio links 140A to 140D are BLs and radio links 150A and 150B are ALs.

A protocol layer, the backhaul adaptation protocol (BAP) layer, located above the radio link control (RLC) layer, is introduced in an IAB system and can be used to realize packet routing, bearer mapping and flow control on the wireless backhaul link.

An F1 interface may be established between an IAB node (e.g., DU part of the IAB node) and an IAB donor (e.g., IAB donor-CU). The F1 interface may support both a user plane protocol (e.g., F1-U) and a control plane protocol (e.g., F1-C). The user plane protocol of the F1 interface may include one or more of a general packet radio service (GPRS) tunneling protocol user plane (GTP-U), user datagram protocol (UDP), internet protocol (IP) and other protocols. The control plane protocol of the F1 interface may include one or more of an F1 application protocol (F1AP), stream control transport protocol (SCTP), IP, and other protocols.

Through the control plane of the F1 interface, an IAB node and an IAB donor can perform, for example, interface management, IAB-DU management, and a UE context-related configuration. Through the user plane of the F1 interface, an IAB node and an IAB donor can perform, for example, user plane data transmission and downlink transmission status feedback functions.

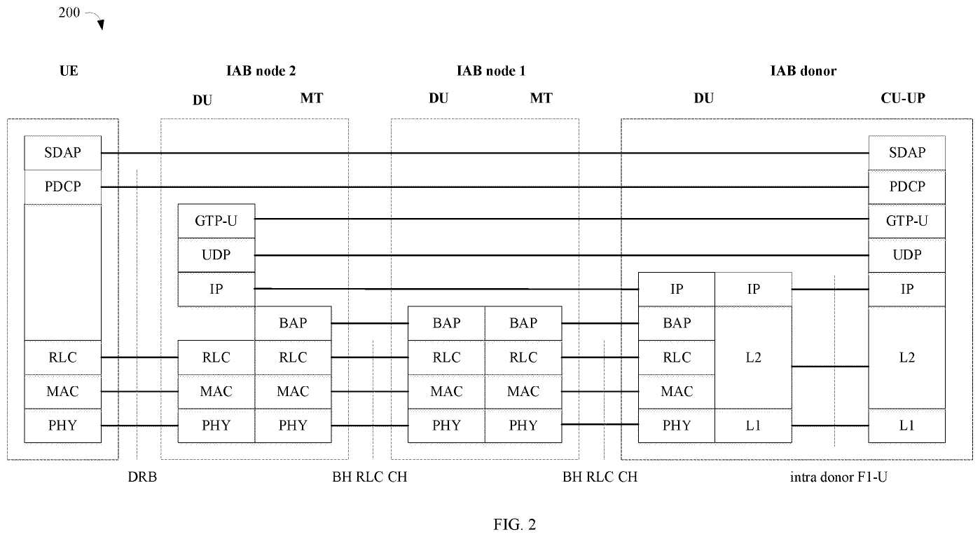

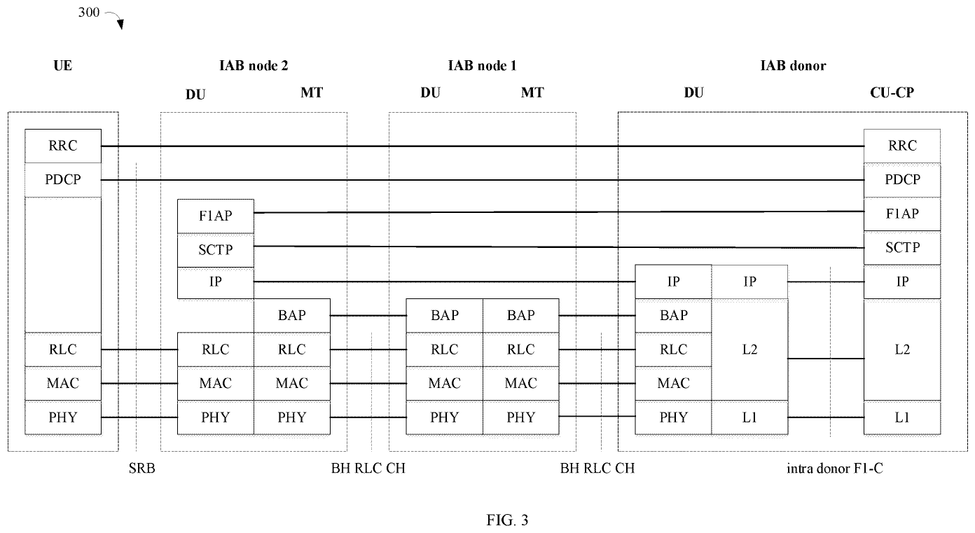

FIG. 2 illustrates an example block diagram of user plane (UP) protocol stack 200 for an IAB network according to some embodiments of the present disclosure. FIG. 3 illustrates an example block diagram of control plane (CP) protocol stack 300 for an IAB network according to some embodiments of the present disclosure. In FIGS. 2 and 3, a UE may be connected to an IAB donor via IAB node 2 and IAB node 1. In some other embodiments of the present disclosure, a UE may be connected to an IAB donor via more or less IAB nodes.

Referring to FIG. 2, the UP protocol stack of the UE may include a service data adaptation protocol (SDAP) layer, a packet data convergence protocol (PDCP) layer, a radio link control (RLC) layer, a medium access control (MAC) layer, and a physical (PHY) layer. The UP protocol stack of the DU of IAB node 2 may include a GTP-U layer, a UDP layer, an IP layer, an RLC layer, a MAC layer, and a PHY layer. The UP protocol stack of the MT of IAB node 2 or the DU or MT of IAB node 1 may include a BAP layer, an RLC layer, a MAC layer, and a PHY layer. The UP protocol stack of the DU of the IAB donor may include an IP layer, a BAP layer, an RLC layer, a MAC layer, and a PHY layer, where the PHY layer belongs to layer 1 (L1), and the BAP layer, the RLC layer, and the MAC layer belong to layer 2 (L2). The protocol stack of the CU-UP of the IAB donor may include a GTP-U layer, a UDP layer, an IP layer, an SDAP layer, a PDCP layer, an L2 layer(s), and an L1 layer.

Referring to FIG. 3, the CP protocol stack of the UE may include a radio resource control (RRC) layer, a PDCP layer, an RLC layer, a MAC layer, and a physical (PHY) layer. The CP protocol stack of the DU of IAB node 2 may include an F1AP layer, an SCTP layer, an IP layer, an RLC layer, a MAC layer, and a PHY layer. The CP protocol stack of the MT of IAB node 2 or the DU or MT of IAB node 1 may include a BAP layer, an RLC layer, a MAC layer, and a PHY layer. The CP protocol stack of the DU of the IAB donor may include an IP layer, a BAP layer, an RLC layer, a MAC layer, and a PHY layer, where the PHY layer belongs to L1, and the BAP layer, the RLC layer, and the MAC layer belong to L2. The protocol stack of the CU-CP of the IAB donor may include an RRC layer, a PDCP layer, an F1AP layer, an SCTP layer, an IP layer, an L2 layer(s), and an L1 layer.

The protocol stacks shown in FIGS. 2 and 3 are only for illustrative purposes. For example, the sequences of some of the protocol layers in the protocol stacks of FIGS. 2 and 3 may be rearranged for illustrative purposes. For example, although the SDAP and PDCP layers belong to L2, they are shown above the GTP-U layer, the UDP layer and the IP layer in the protocol stack of the CU-UP of the IAB donor in FIG. 2.

The signals between each node in an IAB network may include, for example, the following and can be applied to the present disclosure:
an IAB donor-CU and an IAB donor-DU: AN F1 AP Message;
an IAB donor-CU and an IAB node: an F1AP message between the CU and the IAB-DU or an RRC message between the CU and the IAB-MT;
an IAB donor-CU and a UE: an RRC message;
an access IAB node and a UE: L2 control PDU such as a MAC control element (CE) or a RLC control PDU; and
an IAB node and another child or parent IAB node: L2 control PDU such as a MAC CE, a RLC control PDU, or a BAP control PDU.

Regarding BAP routing in an IAB network, each UL or DL packet in a BH link may be mapped to a specific BAP routing identity (ID) and added in the BAP header. The BAP routing ID may be configured by an IAB donor-CU. The BAP routing ID may include a BAP address which indicates the BAP address of a destination node in the BH link. The destination node of the BH link for DL and UL are an access IAB node and an IAB donor-DU, respectively. In addition, the BAP routing ID may further include a path ID which indicates the routing path terminated at the destination node.

As demand for improved cellular coverage and connectivity continues to increase, communications in outdoor and mobility scenarios may face more challenges. In some embodiments of the present disclosure, a mobile wireless network node which acts as a relay between a UE and the 3GPP communication network (e.g., 5G) may be employed to facilitate communications in such scenarios. The mobile wireless network node may provide, for example, an access link to UEs and connected wirelessly (e.g., using NR) through a BS (e.g., donor next-generation radio access network (NG-RAN)) to the core network. In some examples, such mobile wireless network node may also be referred to as a mobile base station relay or mobile relay. The above descriptions with respect to the wireless network node and the IAB node can be applied to the mobile base station relay. That is, a mobile base station relay can be a mobile IAB node.

In some examples, the mobile base station relay may be mounted on a vehicle. The mobile base station relay may serve UEs that are located inside or outside the vehicle, or UEs that enter or leave the vehicle. In the context of the present disclosure, inside or outside of a mobile base station relay may mean inside or outside of a vehicle or other device(s) on which the mobile wireless network node is mounted.

In some examples, the radio link used between a mobile base station relay and the served UEs, as well as between the mobile base station relay and the BS, may be a Uu link (e.g., NR-Uu), which is different from a UE relay (which uses a PC5-based link to provide, for example, indirect connection to remote UEs). In some examples, there may be at least one hop between a UE and a mobile base station relay. In some examples, there may be at least one hop between a mobile base station relay and a BS.

The employment of such mobile wireless network node is advantageous in various aspects and can be applied to various scenarios. For example, in some outdoor environments, the availability of vehicles equipped with mobile base station relays, either following a certain known/predictable itinerary (e.g., buses, trams, etc.), or situated in convenient locations (e.g., outside stadiums, hot-spot areas, or emergency sites), may provide a very opportunistic boost to cellular coverage and capacity when or where needed. Those relays may use, for example, a 5G wireless backhaul toward the macro network, and thus can offer better coverage and connectivity to neighboring UEs. Mobile relays are also very suitable for improving connectivity for users or devices inside a vehicle on which the mobile relay is mounted in different environments, for example, for passengers in buses, cars/taxis, or trains, ad-hoc/professional personnel or equipment. Such mobile wireless network node can also be used for reaching users or devices that would otherwise have no or very poor macro coverage, for example, in the case of first responders dislocated in indoor buildings/areas, using relays placed on their nearby or outside vehicles to get required coverage and connectivity.

The technical benefits of using such mobile wireless network node further include, among others, the ability to get better macro coverage than a nearby UE, for example, exploiting better radio frequency, antenna and power capabilities. In addition, besides the value for network operators and end users, worthy incentives may be found for other parties as well, for example, for vehicle manufacturers, and vehicle and fleet owners or providers, to install and operate relays in their vehicles.

Due to the mobility of a wireless network node (e.g., a mobile base station relay or a mobile IAB node), the wireless network node may need to migrate (or hand over) from one IAB donor to another IAB donor. For example, referring back to FIG. 1, IAB node 120C or IAB node 120B may be migrated from IAB donor 110A to IAB donor 110B. The mobility of a mobile IAB node over a wide area may face challenges that when it changes the IAB donor. For example, the PDCP and RRC connections of the UEs that the mobile IAB node serves would be impacted, so UEs, even if stationary inside the vehicle on which the IAB node is mounted, may experience, for example, potentially a nontrivial amount of signaling, due to the mobility in idle mode (due to the need to adapt the TA values to the new BS assigned values, change PDCP termination and security for the user plane) and connected mode.

The root cause of this mobility related signaling could be mitigated if the mobile IAB node (e.g., DU of the mobile IAB node) can be served by a CU that covers a much wider area (e.g., a city). In some embodiments of the present disclosure, a mobile CU (m-CU) is introduced to mitigate the effect of the IAB donor change. The m-CU may act as a CU for a mobile IAB node or a mobile base station relay. In short, it could be advantageous to offer the homing of a mobile IAB node to a dedicated mobile control unit (e.g., the m-CU) that would control the UEs connected to the mobile IAB node. This would enable the mobile IAB node to move across a much wider RAN coverage area without changing the m-CU. Hence, mobility of the mobile IAB node between IAB donors could be hidden from the UEs connected to the mobile IAB node as long as the controller remains in the same m-CU.

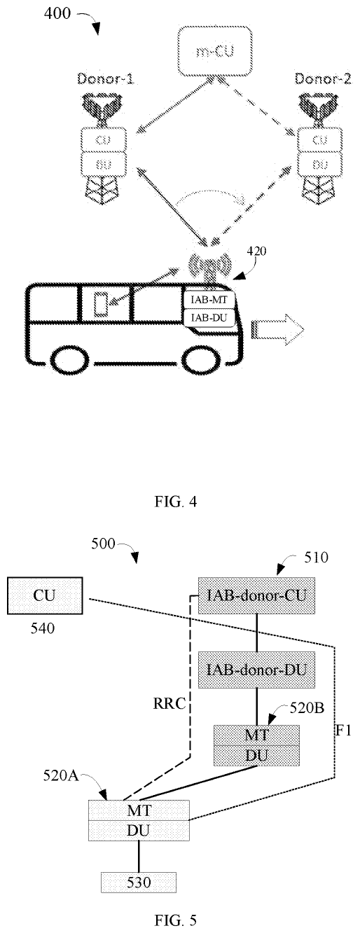

FIG. 4 illustrates a schematic diagram of wireless communication system 400 in accordance with some embodiments of the present disclosure. The wireless communication system 400 may support an m-CU.

Referring to FIG. 4, the wireless communication system 400 may include Donor-1 and Donor-2, each of which includes a CU and a DU, and a wireless network node 420, which includes an IAB-MT and an IAB-DU. Wireless network node 420 may be a mobile wireless network node and mounted on a vehicle and may serve a UE(s) inside the vehicle. Due to the mobility of wireless network node 420, its IAB-MT may switch from Donor-1 to Donor-2; however, the m-CU may always act as the CU for wireless network node 420.

In some embodiments of the present disclosure, in the structure of a wireless network node (e.g., a mobile IAB node or a mobile base station relay) with an m-CU, the MT of the wireless network node is preferred to establish an RRC connection with an IAB donor and the DU of the wireless network node is preferred to establish an F1 connection with the m-CU when the wireless network node performs the integration (i.e., an initial access).

FIG. 5 illustrates a schematic diagram of wireless communication system 500 in accordance with some embodiments of the present disclosure. The wireless communication system 500 may support an m-CU (e.g., CU 540).

Referring to FIG. 5, the wireless communication system 500 may include IAB donor 510, which includes an IAB-donor-CU and an IAB-donor-DU, and wireless network nodes 520A and 520B, each of which includes an MT and a DU. Wireless network node 520B may be directly connected to IAB donor 510. Wireless network node 520A may be a mobile node such as a mobile IAB node.

As shown in FIG. 5, the MT of wireless network node 520A may establish an RRC connection with IAB donor 510 and the DU of wireless network node 520A may set up an F1 connection with CU 540 when wireless network node 520A performs the integration (i.e., an initial access). Embodiments of the present disclosure provide solutions to perform such integration of a wireless network node. More details on the embodiments of the present disclosure will be illustrated in the following text in combination with the appended drawings.

It should be noted that, although embodiments of the present disclosure are discussed under a specific network architecture (e.g., the IAB architecture) and based on certain specific components (e.g., an IAB donor or a mobile IAB node), embodiments of the present disclosure are also applicable to other similar network architectures and new service scenarios.

In some embodiments of the present disclosure, an F1 connection setup between the DU of a wireless network node (hereinafter “mobile-DU” for simplicity) and an m-CU may occur after the establishment of an RRC connection between the MT of the wireless network node (hereinafter “mobile-MT” for simplicity) and the CU of an IAB donor (hereinafter “IAB-donor-CU” for simplicity).

Signaling associated with the F1 connection setup between the mobile-DU and the m-CU should be transported via a backhaul link (e.g., referring to FIG. 5, IAB-donor-DU<-> wireless network node 520B<-> the MT of wireless network node 520A) under the control of an IAB-donor-CU. This means that the UL/DL traffic for the F1 setup to/from the m-CU may need to be configured by an IAB-donor-CU with the backhaul configuration. Therefore, a preparation procedure between the IAB-donor-CU (e.g., IAB-donor-CU shown in FIG. 5) and the m-CU (e.g., CU 540 FIG. 5) to guarantee the UL/DL F1 setup associated signaling transmission via the backhaul link(s) is required.

In the context of the present disclosure, an F1 setup associated message or signaling may include at least one of the following: an F1 setup request from the DU of a network node (e.g., IAB-DU or mobile-DU) to a CU, an F1 setup response from the CU to the DU of the network node, and SCTP association establishment or TNL association establishment signaling between the CU and the DU of the network node.

FIG. 6 illustrates a flow chart of exemplary procedure 600 for wireless communications in accordance with some embodiments of the present disclosure. Procedure 600 can guarantee the UL/DL F1 setup associated signaling transmission via the backhaul link(s) under the IAB-donor-CU. As will be described in detail below, procedure 600 may be used to exchange essential information between the IAB-donor-CU and an m-CU.

Details described in all of the foregoing embodiments of the present disclosure are applicable for the embodiments shown in FIG. 6. For example, BS 610 may function as the IAB donors as described above and may include a CU and a DU. Network node 620 may function as the IAB nodes as described above, and may include an MT and a DU. CU 640 may function as the m-CUs as described above. In some examples, CN entity 650 may be an AMF.

Referring to FIG. 6, in operation 611, network node 620 (e.g., MT of network node 620) may establish an RRC connection with BS 610 (e.g., CU of BS 610). In some examples, network node 620 may be directly connected to BS 610 (e.g., without any other network node connected between network node 620). In some examples, network node 620 may be indirectly connected to BS 610 (e.g., one or more other network nodes may be connected between network node 620 and BS 610).

In some embodiments of the present disclosure, in response to network node 620 setting up the RRC connection to the CU of BS 610, BS 610 may trigger a preparation procedure (e.g., procedure 621 or procedure 631) to facilitate an F1 connection setup between network node 620 and CU 640. In some other embodiments of the present disclosure, the preparation procedure may be triggered by an indication from network node 620 which indicates that network node 620 expects to set up an F1 connection to CU 640. Details of such indication will be described later in the present disclosure.

In some examples, the preparation procedure can be an Xn procedure between BS 610 and CU 640, such as procedure 621.

In some embodiments of the present disclosure, the Xn procedure may be a Class 2 Elementary Procedure which does not have a response message. For example, procedure 621 may only include operation 623.

For example, the CU of BS 610 may initiate the procedure by transmitting information associated network node 620 to facilitate an F1 connection setup between the network node 620 and CU 640 in operation 623. In some examples, the procedure may be referred to as an “IAB-DU setup indication” procedure. The information associated network node 620 may be transmitted in an IAB-DU setup indication message.

In some embodiments, the information associated with network node 620 (or the IAB-DU setup indication message) may include at least one of: IP header information of a DL message associated with the F1 connection setup to network node 620; a BAP address of network node 620; a DU ID (e.g., gNB DU ID) of network node 620; or a global ID (e.g., global gNB ID) of the CU of BS 610. In some embodiments, the IP header information of the DL message associated with the F1 connection setup to network node 620 may include at least one of: a differentiated services code point (DSCP) of the DL message; an IPV6 flow label of the DL message; or an IP address or a transport network layer (TNL) address of network node 620. The above information associated with network node 620 may be used in a later procedure for the F1 connection setup (e.g., in an F1 setup request).

For example, the information associated with network node 620 may include the IP header information. For example, the information associated with network node 620 may include the BAP address of network node 620. For example, the information associated with network node 620 may include the DU ID of network node 620. For example, the information associated with network node 620 may include a global ID of the CU of BS 610 and the BAP address of network node 620, the combination of which may also be referred to as a global ID of network node 620. For example, the information associated with network node 620 may include a global ID of the CU of BS 610 and the gNB DU ID of network node 620, the combination of which may also be referred to as a global ID of network node 620.

For a DL message associated with the F1 connection setup, the CU of BS 610 may configure the DU of BS 610 with the IP header information and associated BAP configuration (e.g., routing and bearer mapping). As the configuration is generated by the CU of BS 610, by employing the above procedure, CU 640 can be aware of the configuration and can generate the proper IP header for the DL message associated with the F1 connection setup.

In some embodiments of the present disclosure, the Xn procedure may be a Class 1 Elementary Procedure which has a response message. For example, procedure 621 may include operations 623 and 625.

For example, the CU of BS 610 may initiate the procedure by transmitting information associated network node 620 to facilitate an F1 connection setup between the network node 620 and CU 640 in operation 623. The above descriptions regarding the information associated network node 620 may also apply here. For example, the information associated with network node 620 may include at least one of: IP header information of a DL message associated with the F1 connection setup to network node 620; a BAP address of network node 620; a DU ID (e.g., gNB DU ID) of network node 620; or a global ID (e.g., global gNB ID) of the CU of BS 610. For example, the IP header information of the DL message associated with the F1 connection setup to network node 620 may include at least one of: a DSCP of the DL message; an IPV6 flow label of the DL message; or an IP address or a TNL address of network node 620.

In some examples, the procedure may be referred to as an “IAB-DU setup preparation” procedure. The information associated network node 620 may be transmitted in an IAB-DU setup request message.

In response to receiving the information associated network node 620 (or the IAB-DU setup request message), CU 640 may respond with an IAB-DU setup response message to the CU of BS 610 in operation 625. Alternatively, in case of failure, CU 640 may respond with an IAB-DU setup refuse/reject message to the CU of BS 610 in operation 625. In some embodiments, in the response message, CU 640 may indicate the IP address of CU 640 to the CU of BS 610. In some embodiments, the response message may only include the acknowledgement of the information from the CU of BS 610.

In some examples, the preparation procedure may involve communications over the NG interface. For example, in the case of no direct Xn connection between the CU of BS 610 and CU 640, the preparation procedure needs to be extended to the NG interface.

For example, the CU of BS 610 may initiate the NG interface procedure by transmitting, to the core network (e.g., CN entity 650), a message (denoted as message #1, which can be an IAB-DU setup request message or another message) in operation 633. In response to message #1, CN entity 650 may initiate an NG interface procedure by transmitting, in operation 635, a message (denoted as message #2, which can be an IAB-DU setup required message or another message) to CU 640 based on the request from the CU of BS 610.

Both message #1 and message #2 may include information associated network node 620 to facilitate an F1 connection setup between the network node 620 and CU 640.

In some embodiments, the information associated with network node 620 may include at least one of: IP header information of a DL message associated with the F1 connection setup to network node 620; a BAP address of network node 620; a DU ID (e.g., gNB DU ID) of network node 620; or a global ID (e.g., global gNB ID) of the CU of BS 610.

For example, the information associated with network node 620 may include IP header information. For example, the information associated with network node 620 may include a global ID of the CU of BS 610 and the BAP address of network node 620, the combination of which may also be referred to as a global ID of network node 620. For example, the information associated with network node 620 may include a global ID of the CU of BS 610 and the gNB DU ID of network node 620, the combination of which may also be referred to as a global ID of network node 620.

The above descriptions regarding the IP header information of the DL message may also apply here. For example, the IP header information of the DL message associated with the F1 connection setup to network node 620 may include at least one of: a DSCP of the DL message; an IPV6 flow label of the DL message; or an IP address or a TNL address of network node 620. The above information associated with network node 620 may be used in a later procedure for an F1 connection setup (e.g., in an F1 setup request).

In some embodiments, message #1 and message #2 may have a corresponding response message.

For example, in operation 637 (denoted by dotted arrow as an option), CU 640 may transmit a response message to CN entity 650 in response to message #2 (e.g., the IAB-DU setup required message or another message). In some embodiments, the response message may include the IP address of CU 640. In some embodiments, the response message may only include the acknowledgement of the information from the CN entity 650.

For example, in operation 639 (denoted by dotted arrow as an option), CN entity 650 may transmit a response message to the CU of BS 610 in response to message #1 (e.g., the IAB-DU setup request message or another message). In some embodiments, the response message may include the IP address of CU 640. In some embodiments, the response message may only include the acknowledgement of the information from the CU of BS 610.

In some embodiments, message #1, message #2 or both may do not have a corresponding response message. That is, operation 637, operation 639 or both may be omitted.

Procedure 600 can also be applied to the scenario of the DU migration of a network node without the involvement of an m-CU. For example, the CU of BS 610 in FIG. 6 can be implemented as a CU (e.g., a donor CU) which has an RRC connection with network node 620, and CU 640 in FIG. 6 can be implemented as another CU (e.g., another donor CU) to which the DU of network node 620 will set up the F1 connection. Further clarification in this regard will be described in the following text.

It should be appreciated by persons skilled in the art that the sequence of the operations in exemplary procedure 600 may be changed and some of the operations in exemplary procedure 600 may be eliminated or modified, without departing from the spirit and scope of the disclosure.

In some embodiments of the present disclosure, during the integration, a wireless network node can set up an F1 connection with an IAB donor or an m-CU. Embodiments of the present disclosure provide procedures for a wireless network node to set up an F1 connection with an IAB donor or an m-CU. In addition, embodiments of the present disclosure also provide a discovery procedure for the IAB donor to find the m-CU before the F1 connection setup. In the case that a wireless network node is to setup an F1 connection with the m-CU, the IAB donor may find the m-CU in advance according to the discovery procedure, so as to communicate between the IAB donor and m-CU in preparation for the setup of the DU of the wireless network node.

In some embodiments of the present disclosure, for the CU of each IAB donor, a corresponding m-CU may be preconfigured via an operation, administration and maintenance (OAM).

In some embodiments of the present disclosure, the CU of an IAB donor may be aware of the existence of an m-CU before the integration of a wireless network node (e.g., a mobile IAB node).

In some embodiments of the present disclosure, the CU of an IAB donor may initiate a discovery procedure for an m-CU. For example, the CU of an IAB donor may find an m-CU via an Xn setup procedure between the CU of an IAB donor and the m-CU.

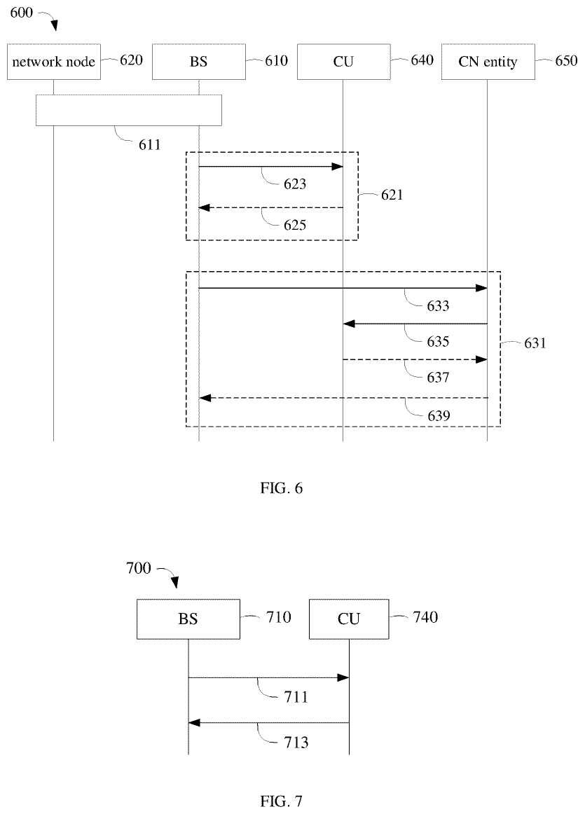

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7. For example, BS 710 may function as the IAB donors as described above and may include a CU and a DU. CU 740 may function as the m-CUs as described above.

Referring to FIG. 7, BS 710 (e.g., CU of BS 710) may initiate the discovery procedure by transmitting an Xn setup request message (or another message) to CU 740 in operation 711. In operation 713, CU 740 may reply with an Xn setup response message (or another message) to BS 710 (e.g., CU of BS 710). In some embodiments of the present disclosure, the Xn setup response message may include an indication indicating that CU 740 is a mobile CU specific for a mobile network node.

In some other embodiments, the above indication may be carried in an NG-RAN node configuration update acknowledge message in an NG-RAN node configuration update procedure. For example, BS 710 (e.g., CU of BS 710) may trigger the NG-RAN node configuration update procedure (e.g., as the discovery procedure) and transmit an NG-RAN node configuration update message in operation 711.

It should be appreciated by persons skilled in the art that the sequence of the operations in exemplary procedure 700 may be changed and some of the operations in exemplary procedure 700 may be eliminated or modified, without departing from the spirit and scope of the disclosure.

In some embodiments of the present disclosure, an m-CU may initiate a discovery procedure. For example, a CU of an IAB donor may find the m-CU via an Xn setup procedure between the CU of an IAB donor and the m-CU.

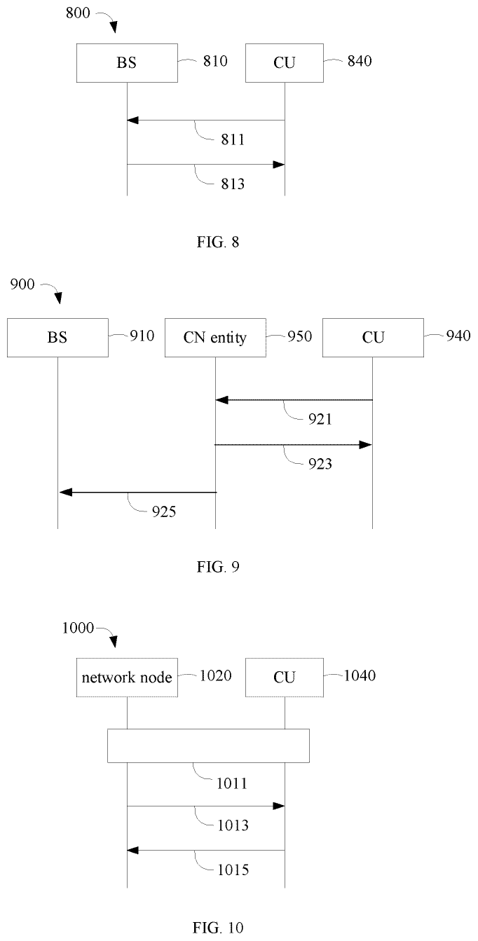

FIG. 8 illustrates a flow chart of exemplary procedure 800 for wireless communications in accordance with some embodiments of the present disclosure. Details described in all of the foregoing embodiments of the present disclosure are applicable for the embodiments shown in FIG. 8. For example, BS 810 may function as the IAB donors as described above and may include a CU and a DU. CU 840 may function as the m-CUs as described above.

Referring to FIG. 8, CU 840 may initiate the discovery procedure by transmitting an Xn setup request message (or another message) to BS 810 (e.g., CU of BS 810) in operation 811. In operation 813, BS 810 (e.g., CU of BS 810) may reply with an Xn setup response message (or another message) to CU 840. In some embodiments of the present disclosure, the Xn setup request message may include an indication indicating that CU 840 is a mobile CU specific for a mobile network node.

In some other embodiments, the above indication may be carried in an NG-RAN node configuration update message in an NG-RAN node configuration update procedure. For example, CU 840 may trigger the NG-RAN node configuration update procedure (e.g., as the discovery procedure) and transmit an NG-RAN node configuration update message in operation 811.

It should be appreciated by persons skilled in the art that the sequence of the operations in exemplary procedure 800 may be changed and some of the operations in exemplary procedure 800 may be eliminated or modified, without departing from the spirit and scope of the disclosure.

In some embodiments of the present disclosure, the CU of an IAB donor may find the m-CU via the NG interface.

FIG. 9 illustrates a flow chart of exemplary procedure 900 for wireless communications in accordance with some embodiments of the present disclosure. Details described in all of the foregoing embodiments of the present disclosure are applicable for the embodiments shown in FIG. 9. For example, BS 910 may function as the IAB donors as described above and may include a CU and a DU. CU 940 may function as the m-CUs as described above. CN entity 950 may function as the CN entities as described above.

Referring to FIG. 9, CU 940 may first initiate an NG Setup procedure to core network. For example, in operation 921, CU 940 may transmit an NG setup request message to CN entity 950. In some embodiments, the NG setup request message may indicate that CU 940 is a mobile CU specific for a mobile network node.

In operation 923, CN entity 950 may respond with an NG setup response message to CU 940.

In operation 925, in response to the NG setup request message, CN entity 950 may transmit an identifier of CU 940 to BS 910 (e.g., CU of BS 910) via an NG message. The identifier may be a global RAN Node ID or any other global identifier of CU 940. The NG message may be an NG setup response message, a RAN configuration update acknowledge message or an AMF configuration update.

It should be appreciated by persons skilled in the art that the sequence of the operations in exemplary procedure 900 may be changed and some of the operations in exemplary procedure 900 may be eliminated or modified, without departing from the spirit and scope of the disclosure. For example, operation 925 may precede or occur at the same time as operation 923 in some other embodiments of the present disclosure.

As mentioned above, the F1 termination CU of a wireless network node (e.g., mobile IAB node) can be the CU of a BS (e.g., IAB donor) or an m-CU. Various embodiments can be applied to the determination or selection of the F1 termination CU of the wireless network node.

In some embodiments of the present disclosure, the F1 termination CU of a wireless network node (e.g., mobile IAB node) may be determined by the CU of a BS (e.g., IAB donor).

For example, in response to a wireless network node (e.g., MT of a mobile IAB node) initiating an RRC connection setup with the CU of a BS, the CU of the BS may indicate the wireless network node to set up an F1 connection to the CU of the BS or to an m-CU. The indication may be transmitted via an RRC message.

For example, in some embodiments, the indication may indicate either the CU of the BS or an m-CU is the F1 termination CU of the wireless network node. For example, in some embodiments, the CU of the BS may only transmit the indication when the F1 termination CU of the wireless network node is an m-CU. That is, in the absence of the indication, the wireless network node should set up an F1 connection to the CU of the BS.

In some embodiments of the present disclosure, the F1 termination CU of a wireless network node (e.g., mobile IAB node) may be determined by the wireless network node.

For example, in the case that a wireless network node wants to set up an F1 connection to an m-CU, the wireless network node may transmit an indication to the CU of a BS to indicate that it will set up the F1 connection to the m-CU so that the CU of a BS can perform a preparation procedure in advance. The indication can be included in an RRC message, for example, a message 5 during the initial access procedure. The preparation procedure described above with respect to FIG. 6 may apply here. For example, referring back to FIG. 6, in response to receiving an indication from network node 620 which indicates a determination of an F1 connection setup to a CU different from the CU of BS 610 (e.g., a m-CU), BS 610 may perform procedure 621 or procedure 631 to facilitate the F1 connection setup.

In some embodiments of the present disclosure, in the case that the MT and DU of a wireless network node terminate at different CUs (e.g., a CU of an IAB donor and an m-CU, respectively, or different CUs of different IAB-donors), a procedure for associating the MT and DU of the wireless network node may be required. For example, an F1 setup request message from the DU of a wireless network node to the m-CU may need to be associated with the information transmitted from the CU of an IAB donor to the m-CU. Embodiments of the present disclosure provide solutions for solving the above issues.

FIG. 10 illustrates a flow chart of exemplary procedure 1000 for wireless communications in accordance with some embodiments of the present disclosure. Details described in all of the foregoing embodiments of the present disclosure are applicable for the embodiments shown in FIG. 10. For example, network node 1020 may function as the IAB nodes as described above, and may include an MT and a DU. CU 1040 may function as the m-CUs as described above.

Referring to FIG. 10, network node 1020 (e.g., MT of network node 1020) may have an RRC connection with the CU of a BS (e.g., IAB-donor-CU), which is not shown in FIG. 10. In operation 1011, network node 1020 (e.g., DU of network node 1020) may establish the first transport network layer association (TNLA) TNLA (or an SCTP association) with CU 1040. In some embodiments, the TNL or IP address of CU 1040 can be preconfigured by an OAM. In some embodiments, the TNL or IP address of CU 1040 can be obtained from CU 1040 via an Xn message or from a core network via an NG message, for example, as described with respect to operation 625 or operation 639 in FIG. 6.

Network node 1020 (e.g., DU of network node 1020) may initiate an F1 setup procedure and may transmit an F1 setup request message to CU 1040 in operation 1013. In some embodiments, the F1 setup request message may include information to assist CU 1040 to associate the DU of network node 1020 and the information indicated from the CU of the BS (e.g., IAB-donor-CU) specific for network node 1020. For example, some information elements (IEs) of the F1 setup request message may be the same as the information associated with a network node to facilitate an F1 connection setup as described with respect to FIG. 6.

For example, the F1 setup request message may include a global ID of network node 1020. In some embodiments, the global ID of network node 1020 may include at least one of the following: a global ID of the CU of the BS (e.g., IAB-donor-CU) and a BAP address of network node 1020; a global ID of the CU of the BS and a DU ID (e.g., gNB-DU ID) of network node 1020; or an IP address of network node 1020. The global ID of the CU of a BS may be a global gNB ID.

In operation 1015, CU 1040 may transmit an F1 setup response message to network node 1020 (e.g., DU of network node 1020) in response to the F1 setup request message.

It should be noted that all the message between network node 1020 (e.g., DU of network node 1020) and CU 1040 may be transmitted via the BH links in the topology of the CU of the BS (e.g., IAB-donor-CU). For example, referring back to FIG. 5, the DL traffic may be transmitted from CU 540 to the IAB-donor-DU of the IAB-donor-CU, and the IAB-donor-DU may deliver the DL traffic to wireless network node 520A via the BH links. The UL traffic may be transmitted via the same path in the reverse direction.

Procedure 1000 can also be applied to the scenario of the DU migration of a network node without the involvement of an m-CU. For example, the CU of the BS can be implemented as a CU (e.g., a donor CU) which has an RRC connection with network node 1020, and CU 1040 in FIG. 10 can be implemented as another CU (e.g., another donor CU) to which the DU of network node 1020 will set up the F1 connection. Further clarification in this regard will be described in the following text.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

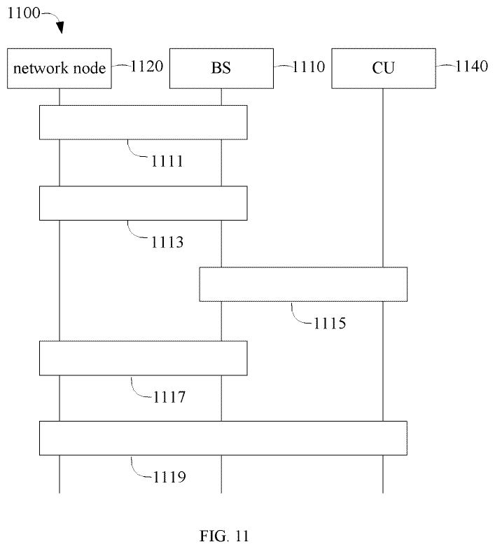

FIG. 11 illustrates a flow chart of exemplary procedure 1100 for wireless communications in accordance with some embodiments of the present disclosure. Details described in all of the foregoing embodiments of the present disclosure are applicable for the embodiments shown in FIG. 11. For example, BS 1110 may function as the IAB donors as described above and may include a CU and a DU. CU 1140 may function as the m-CUs as described above. Network node 1120 may function as the IAB nodes as described above.

Procedure 1100 may be employed for the integration of a wireless network node (e.g., a mobile IAB node) with the architecture of an m-CU. In procedure 1100, the MT of network node 1120 may firstly establish an RRC connection to the CU of BS 1110, and then the DU of network node 1120 may set up an F1 connection to CU 1140 via the BH links under the CU of BS 1110.

Referring to FIG. 11, in operation 1111, the MT of network node 1120 may establish an RRC connection to the CU of BS 1110.

In this operation, the MT of network node 1120 may connect to the network in the same way as a UE, for example, by performing an RRC connection setup procedure with the CU of BS 1110, an authentication with the core network, an IAB-node related context management, an IAB-node's access traffic-related radio bearer configuration at the RAN side (e.g., signaling radio bearers (SRBs) and optionally data radio bearers (DRBs)), and, optionally, OAM connectivity establishment by using the IAB-MT's PDU session.

In operation 1113, the CU of BS 1110 or network node 1120 may determine the F1 termination CU of network node 1120.

For example, in some embodiments, the CU of BS 1110 may indicate network node 1120 to set up an F1 connection to the CU of BS 1110 or CU 1140, as described in previous embodiments. Such indication can be sent via RRC signaling. In some embodiments, network node 1120 may transmit an indication to the CU of BS 1110 that it wants to set up an F1 connection to a CU (e.g., an m-CU such as CU 1140) different from the CU of BS 1110, as described in previous embodiments. In the case that the above indication indicates an F1 connection to CU 1140, the procedure goes to operation 1115.

In operation 1115, a negotiation may be performed between the CU of BS 1110 and CU 1140.

For example, the CU of BS 1110 may discover CU 1140 via a procedure as described above with respect to FIGS. 7-9. It should be noted that such discovery procedure may be performed before operation 1113 or operation 1111. For example, the CU of BS 1110 and CU 1140 may perform a procedure as described above with respect to FIG. 6 (e.g., procedure 621 or 631 in FIG. 6).

In operation 1117, the CU of BS 1110 may configure the BH configuration for the BH links between the DU of BS 1110 and network node 1120 to guarantee the DL/UL transmission of an F1 setup related message.

For example, for the DL, the CU of BS 1110 may initiate an FAP procedure to configure the DU of BS 1110 with the mapping from an IP header field(s) to the BAP routing ID related to network node 1120. The routing tables and BH RLC CHs may be updated on all ancestor network nodes (e.g., IAB nodes), if any, and on the DU of BS 1110, with routing entries for the new BAP routing ID(s) associated with network node 1120.

For the UL, a default configuration which includes default BH RLC channel and default BAP routing ID may be configured to network node 1120 for a UL F1 setup related message. In some examples, the UL BH configuration for the BH links between network node 1120 and the DU of BS 1110 may also be updated.

In operation 1119, network node 1120 (e.g., DU of network node 1120) may set up an F1 connection with CU 1140. For example, the procedure as described above with respect to FIG. 10 may apply here.

It should be appreciated by persons skilled in the art that the sequence of the operations in exemplary procedure 1100 may be changed and some of the operations in exemplary procedure 1100 may be eliminated or modified, without departing from the spirit and scope of the disclosure.

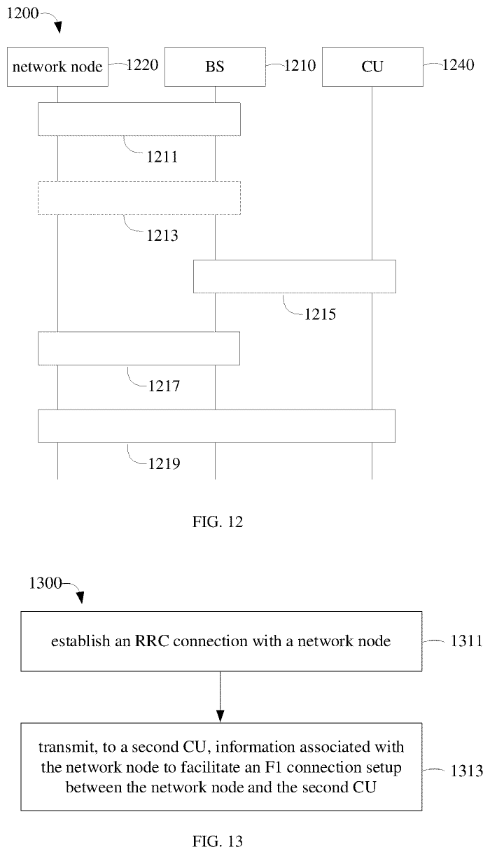

FIG. 12 illustrates a flow chart of exemplary procedure 1200 for wireless communications in accordance with some embodiments of the present disclosure. Details described in all of the foregoing embodiments of the present disclosure are applicable for the embodiments shown in FIG. 12. For example, BS 1210 may function as the IAB donors as described above and may include a CU and a DU. Network node 1220 may function as the IAB nodes as described above. CU 1240 may function as the m-CUs, the CU of a BS, or the CU of an IAB donor as described above.

In some embodiments, procedure 1200 may be employed for the integration of a wireless network node (e.g., a mobile IAB node) with the architecture of an m-CU. In such embodiments, CU 1240 may function as the m-CU. In some embodiments, procedure 1200 may be employed for the migration of the DU of a wireless network node (e.g., a mobile IAB node) without the involvement of an m-CU. In such embodiments, CU 1240 may function as the CU of a BS or the CU of an IAB donor.

In procedure 1200, the MT of network node 1220 may firstly establish an RRC connection to the CU of BS 1210, then the DU (DU1) of network node 1220 may set up an F1 connection to the CU of BS 1210, and finally another DU (DU2) of network node 1220 may set up an F1 connection to CU 1240.

Referring to FIG. 12, in operation 1211, network node 1220 may perform the integration to the CU of BS 1210. For example, operation 1211 may include an IAB-MT setup procedure, a BH RLC channel establishment procedure, a routing update procedure, and an IAB-DU part setup procedure.

For example, during the IAB-MT setup procedure, the MT of network node 1220 may connect to the network in the same way as a UE. Network node 1220 can select the parent node for access based on an over-the-air indication from the potential parent node IAB-DU, which may be transmitted in system information block 1 (SIB1)). In some examples, to indicate its IAB capability, the MT of network node 1220 may include an IAB-node indication in an RRC setup complete message, to assist BS 1210 to select an AMF supporting IAB.

For example, in the BH RLC channel establishment procedure, during the bootstrapping procedure, one default BH RLC channel for non-UP traffic, e.g., carrying F1-C traffic/non-F1 traffic to and from network node 1220 in the integration phase, may be established. This may require the setup of a new BH RLC channel or the modification of an existing BH RLC channel between a parent node of network node 1220 (if any) and the DU of BS 1210. The CU of BS 1210 may establish additional (non-default) BH RLC channels. This procedure may also include configuring the BAP address of network node 1220 and default BAP routing ID for the upstream direction.

For example, in the routing update procedure, the BAP layer may be updated to support routing between network node 1220 and the DU of BS 1210. For the downstream direction, the CU of BS 1210 may initiate an FIAP procedure to configure the DU of BS 1210 with the mapping from an IP header field(s) to the BAP routing ID related to network node 1220. The routing tables may be updated on all ancestor network nodes of network node 1220 and on the DU of BS 1210, with routing entries for the new BAP Routing ID(s). This procedure may also include the IP address allocation procedure for network node 1220. Network node 1220 may request one or more IP addresses from the CU of BS 1210 via RRC. The CU of BS 1210 may send the IP address(es) to network node 1220 via RRC. The CU of BS 1210 may obtain the IP address(es) from the DU of BS 1210 via F1AP or by other means (e.g., OAM, dynamic host configuration protocol (DHCP), and so on). An IP address allocation procedure may occur at any time after the RRC connection has been established.

For example, in IAB-DU part setup procedure, the DU (e.g., DU1) of network node 1220 may be configured via the OAM. The DU (e.g., DU1) of network node 1220 may initiate a TNL establishment, and F1 connection setup with the CU of BS 1210 using the allocated IP address(es). The CU of BS 1210 may discover collocation of the MT of network node 1220 and the DU (e.g., DU1) of network node 1220 from the BAP address included in the F1 setup request message. After the F1 connection is set up, network node 1220 can start serving the UEs.

In the architecture of an m-CU (e.g., CU 1240 being an m-CU), the CU of BS 1210 or network node 1220 may determine the F1 termination CU of network node 1220 in operation 1213 (denoted by dotted arrow as an option). For example, the CU of BS 1210 may indicate network node 1220 to set up an F1 connection to the CU of BS 1210 or CU 1240, as described in previous embodiments. Such indication can be sent via RRC signaling. In some embodiments, network node 1220 may transmit an indication to the CU of BS 1210 that it wants to set up an F1 connection to an m-CU, as described in previous embodiments. In the case that the above indication indicates an F1 connection to CU 1240, the procedure goes to operation 1215.

In the case of DU migration without the involvement of an m-CU (e.g., CU 1240 being the CU of another BS), the CU of BS 1210 may trigger the F1 migration for network node 1220, and indicate network node 1220 to setup an F1 connection to a target CU (e.g., CU 1240).

In operation 1215, a negotiation may be performed between the CU of BS 1210 and CU 1240 (which may be an m-CU of a CU of another BS).

For example, in the architecture of an m-CU (e.g., CU 1240 being an m-CU), the CU of BS 1210 may discover CU 1240 via a procedure as described above with respect to FIGS. 7-9. It should be noted that such discovery procedure may be performed before operation 1213 or operation 1211. For example, the CU of BS 1210 and CU 1240 may perform a negotiation procedure as described above with respect to FIG. 6 (e.g., procedure 621 or 631 in FIG. 6).

For example, in the case of DU migration without the involvement of an m-CU (e.g., CU 1240 being the CU of another BS), the CU of BS 1210 may find CU 1240 based on a measurement report.

In operation 1217, the CU of BS 1210 may configure the BH configuration for the BH links between the DU of BS 1210 and network node 1220 to guarantee the DL/UL transmission of an F1 setup related message.

For example, for the DL, the CU of BS 1210 may initiate an F1AP procedure to configure the DU of BS 1210 with the mapping from an IP header field(s) to the BAP routing ID related to network node 1220. The routing tables and BH RLC CHs may be updated on all ancestor network nodes (e.g., IAB nodes), if any, and on the DU of BS 1210, with routing entries for the new BAP routing ID(s) associated with network node 1220.

For the UL, a UL F1 setup related message may reuse the UL BH configuration with the mapping between non-UP traffic type to the BAP routing ID and the egress BH RLC CH. The DU of BS 1210 may deliver a UL F1 setup related message to CU 1240 (e.g., an m-CU or the CU of another BS) based on the target IP address.

In operation 1219, network node 1220 (e.g., another DU (e.g., DU2) of network node 1220) may set up an F1 connection with CU 1240 (e.g., an m-CU or the CU of another BS). For example, the procedure as described above with respect to FIG. 10 may apply here.

Different from procedure 1100 in FIG. 11, network node 1220 has two logical DUs (e.g., DU1 and DU2), and DU2 sets up the F1 connection to CU 1240 (e.g., an m-CU or the CU of another BS).

In some embodiments, the CU of BS 1210 may hand over all served UEs of network node 1220 to DU2 connected to CU 1240 (e.g., an m-CU or the CU of another BS), and then remove the F1 connection between DU1 and the CU of BS 1210.

It should be appreciated by persons skilled in the art that the sequence of the operations in exemplary procedure 1200 may be changed and some of the operations in exemplary procedure 1200 may be eliminated or modified, without departing from the spirit and scope of the disclosure.

FIG. 13 illustrates a flow chart of exemplary procedure 1300 for wireless communications in accordance with some embodiments of the present disclosure. Details described in all of the foregoing embodiments of the present disclosure are applicable for the embodiments shown in FIG. 13. Exemplary procedure 1300 may be performed by a BS (e.g., an IAB donor), or more specifically, the CU of the BS (e.g., an IAB-donor-CU).

Referring to FIG. 13, in operation 1311, a CU (denoted as “first CU” for clarity) may establish an RRC connection with a network node. The network node may be an IAB node.

In operation 1313, the first CU may transmit, to another CU (denoted as “second CU” for clarity), information associated with the network node to facilitate an F1 connection setup between the network node and the second CU. In some embodiments of the present disclosure, the second CU may be a donor CU or a mobile CU.

In some embodiments of the present disclosure, the information associated with the network node may include at least one of: IP header information of a DL message associated with the F1 connection setup to the network node; a BAP address of the network node; a DU ID of the network node; or a global ID of the first CU. In some embodiments of the present disclosure, the IP header information of the DL message associated with the F1 connection setup to the network node may include at least one of: a DSCP of the DL message; an IPV6 flow label of the DL message; or an IP address or a TNL address of the network node.

In some embodiments of the present disclosure, the information associated with the network node may be transmitted to the second CU via an Xn interface between the first CU and the second CU. In some embodiments of the present disclosure, the information associated with the network node may be transmitted to the second CU via a core network entity.

In some embodiments of the present disclosure, transmitting the information associated with the network node may include transmitting the information associated with the network node in response to the RRC connection establishment between the first CU and the network node, or in response to an indication from the network node which indicates a determination of an F1 connection setup to a CU different from the first CU.

In some embodiments of the present disclosure, the first CU may transmit, to the network node, an indication indicating the network node to set up an F1 connection to a CU different from the first CU. In some embodiments of the present disclosure, the first CU may receive, from the network node, an indication indicating that the network node determines to set up an F1 connection to a CU different from the first CU.

In some embodiments of the present disclosure, the first CU may receive, from the second CU, an indication indicating that the second CU is a mobile CU specific for a mobile network node. In some embodiments of the present disclosure, the first CU may receive, from a core network entity, an identifier of the second CU, wherein the second CU is a mobile CU specific for a mobile network node. In some embodiments of the present disclosure, the indication may be included in one of the following messages from the second CU to the first CU: an Xn setup response message; an Xn setup request message; an NG-RAN node configuration update acknowledge message; and an NG-RAN node configuration update message.

It should be appreciated by persons skilled in the art that the sequence of the operations in exemplary procedure 1300 may be changed and some of the operations in exemplary procedure 1300 may be eliminated or modified, without departing from the spirit and scope of the disclosure.

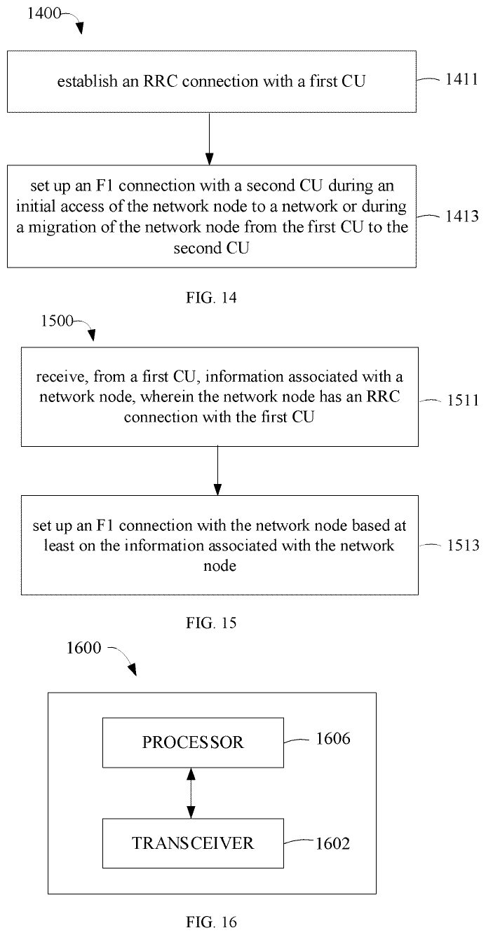

FIG. 14 illustrates a flow chart of exemplary procedure 1400 for wireless communications in accordance with some embodiments of the present disclosure. Details described in all of the foregoing embodiments of the present disclosure are applicable for the embodiments shown in FIG. 14. Exemplary procedure 1400 may be performed by a network node (e.g., an IAB node).

Referring to FIG. 14, in operation 1411, a network node may establish an RRC connection with a CU (denoted as “first CU” for clarity). In operation 1413, the network node may set up an F1 connection with another CU (denoted as “second CU” for clarity) during an initial access of the network node to a network or during a migration of the network node from the first CU to the second CU.

In some embodiments of the present disclosure, the network node may receive, from the first CU, an indication indicating the network node to set up an F1 connection to a CU different from the first CU. In some embodiments of the present disclosure, the network node may transmit, to the first CU, an indication indicating that the network node determines to set up an F1 connection to a CU different from the first CU.

In some embodiments of the present disclosure, the network node may transmit, to the second CU, an F1 setup request message, wherein the F1 setup request message may include a global ID of the network node. In some embodiments of the present disclosure, the global ID of the network node may include at least one of the following: a global ID of the first CU and a BAP address of the network node; a global ID of the first CU and a DU ID of the network node; or an IP address of the network node.

It should be appreciated by persons skilled in the art that the sequence of the operations in exemplary procedure 1400 may be changed and some of the operations in exemplary procedure 1400 may be eliminated or modified, without departing from the spirit and scope of the disclosure.

FIG. 15 illustrates a flow chart of exemplary procedure 1500 for wireless communications in accordance with some embodiments of the present disclosure. Details described in all of the foregoing embodiments of the present disclosure are applicable for the embodiments shown in FIG. 15. Exemplary procedure 1500 may be performed by an m-CU or a BS (or more specifically, the CU of the BS (e.g., an IAB-donor-CU)).

Referring to FIG. 15, in operation 1511, a CU (denoted as “second CU” for clarity) may receive, from another CU (denoted as “first CU” for clarity), information associated with a network node, wherein the network node has an RRC connection with the first CU. In some embodiments of the present disclosure, the second CU may be a donor CU or a mobile CU. The network node may be an IAB node. The first CU may be an IAB-donor-CU.

In operation 1513, the second CU may set up an F1 connection with the network node based at least on the information associated with the network node.

In some embodiments of the present disclosure, the information associated with the network node may include at least one of: IP header information of a DL message associated with the F1 connection setup to the network node; a BAP address of the network node; a DU ID of the network node; or a global ID of the first CU. In some embodiments of the present disclosure, the IP header information of the DL message associated with the F1 connection setup to the network node may include at least one of: a DSCP of the DL message; an IPV6 flow label of the DL message; or an IP address or a TNL address of the network node.

In some embodiments of the present disclosure, the information associated with the network node may be received from the first CU via an Xn interface between the first CU and the second CU. In some embodiments of the present disclosure, the information associated with the network node may be received from the first CU via a core network entity.

In some embodiments of the present disclosure, the second CU may transmit, to the first CU or a core network entity, an indication indicating that the second CU is a mobile CU specific for a mobile network node. In some embodiments of the present disclosure, the indication may be included in one of the following message: an Xn setup response message from the second CU to the first CU; an Xn setup request message from the second CU to the first CU; an NG-RAN node configuration update acknowledge message from the second CU to the first CU; an NG-RAN node configuration update message from the second CU to the first CU; and an NG setup request message from the second CU to the core network entity.

In some embodiments of the present disclosure, the second CU may receive, from the network node, an F1 setup request message, wherein the F1 setup request message may include a global ID of the network node. In some embodiments of the present disclosure, the global ID of the network node may include at least one of the following: a global ID of the first CU and a BAP address of the network node; a global ID of the first CU and a DU ID of the network node; or an IP address of the network node.

It should be appreciated by persons skilled in the art that the sequence of the operations in exemplary procedure 1500 may be changed and some of the operations in exemplary procedure 1500 may be eliminated or modified, without departing from the spirit and scope of the disclosure.

FIG. 16 illustrates a block diagram of exemplary apparatus 1600 according to some embodiments of the present disclosure.

As shown in FIG. 16, the apparatus 1600 may include at least one processor 1606 and at least one transceiver 1602 coupled to the processor 1606. The apparatus 1600 may be a network node (e.g., an IAB node), a BS (e.g., an IAB donor, IAB donor-CU, or IAB donor-DU), a DU of a BS, a CU of a BS, or an m-CU. In the case that apparatus 1600 is a BS, apparatus 1600 may further include a CU and a DU coupled to the CU. The CU and DU may be co-located or located separately. The CU and DU may be coupled to the processor 1606. In the case that apparatus 1600 is a network node, apparatus 1600 may further include a MT and a DU coupled to the MT. The MT and DU may be coupled to the processor 1606.

Although in this figure elements such as the at least one transceiver 1602 and processor 1606 are described in the singular, the plural is contemplated unless a limitation to the singular is explicitly stated. In some embodiments of the present application, the transceiver 1602 may be divided into two devices, such as a receiving circuitry and a transmitting circuitry. In some embodiments of the present application, the apparatus 1600 may further include an input device, a memory, and/or other components.

In some embodiments of the present application, the apparatus 1600 may be a BS. The processor 1606 may interact with other element(s) (e.g., transceiver 1602, a DU, or a CU) of the apparatus 1600 so as to perform the operations with respect to the BSs, the IAB donors, IAB donor-CUs, or IAB donor-DUs described in FIGS. 1-15. In some embodiments of the present application, the apparatus 1600 may be a network node. The transceiver 1602 and the processor 1606 may interact with each other so as to perform the operations with respect to the network nodes or the IAB nodes (mobile or stationary) described in FIGS. 1-15. In some embodiments of the present application, the apparatus 1600 may be a CU (e.g., m-CU or a CU of a BS). The transceiver 1602 and the processor 1606 may interact with each other so as to perform the operations with respect to the CUS (e.g., m-CU or a CU of a BS) described in FIGS. 1-15.

In some embodiments of the present application, the apparatus 1600 may further include at least one non-transitory computer-readable medium.

In some embodiments of the present disclosure, the non-transitory computer-readable medium may have stored thereon computer-executable instructions to cause the processor 1606 to implement the method with respect to the BSs, the IAB donors, IAB donor-CUs, or IAB donor-DUs as described above. For example, the computer-executable instructions, when executed, cause the processor 1606 interacting with, for example, transceiver 1602 to perform the operations with respect to the BSs, the IAB donors, IAB donor-CUs, or IAB donor-DUs described in FIGS. 1-15.

For example, in some embodiments of the present disclosure, the non-transitory computer-readable medium may have stored thereon computer-executable instructions to cause the processor 1606 to implement the method with respect to the network nodes or the IAB nodes (mobile or stationary) as described above. For example, the computer-executable instructions, when executed, cause the processor 1606 interacting with transceiver 1602 to perform the operations with respect to the network nodes or the IAB nodes (mobile or stationary) described in FIGS. 1-15.

For example, in some embodiments of the present disclosure, the non-transitory computer-readable medium may have stored thereon computer-executable instructions to cause the processor 1606 to implement the method with respect to the CUS (e.g., m-CU or a CU of a BS) as described above. For example, the computer-executable instructions, when executed, cause the processor 1606 interacting with transceiver 1602 to perform the operations with respect to the CUS (e.g., m-CU or a CU of a BS) described in FIGS. 1-15.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover,” “path switch,” and “migration” may be used interchangeably. The terms “includes,” “including,” or any other variations thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first centralized unit (CU), comprising:
at least one memory; and
at least one processor coupled with the at least one memory and configured to cause the first CU to:
establish a radio resource control (RRC) connection with a network node; and
transmit, to a second CU, information associated with the network node to facilitate an F1 connection setup between the network node and the second CU.

2. The first CU of claim 1, wherein the information associated with the network node comprises at least one of:
internet protocol (IP) header information of a downlink (DL) message associated with the F1 connection setup to the network node;
a backhaul adaptation protocol (BAP) address of the network node;
a distributed unit (DU) ID of the network node; or
a global ID of the first CU.

3. The first CU of claim 2, wherein the IP header information of the DL message associated with the F1 connection setup to the network node comprises at least one of:
a differentiated services code point (DSCP) of the DL message;
an IPv6 flow label of the DL message; or
an IP address or a transport network layer (TNL) address of the network node.

4. The first CU of claim 1, wherein to transmit the information associated with the network node, the at least one processor is further configured to cause the first CU to transmit the information associated with the network node in response to the RRC connection establishment between the first CU and the network node, or in response to an indication from the network node which indicates a determination of an F1 connection setup to a CU different from the first CU.

5. The first CU of claim 1, wherein the at least one processor is further configured to cause the first CU to:
transmit, to the network node, an indication indicating to the network node to set up an F1 connection to a CU different from the first CU; or
receive, from the network node, an indication indicating that the network node determines to set up an F1 connection to a CU different from the first CU.

6. The first CU of claim 1, wherein the at least one processor is further configured to cause the first CU to:
receive, from the second CU, an indication indicating that the second CU is a mobile CU specific for a mobile network node; or receive, from a core network entity, an identifier of the second CU, wherein the second CU is a mobile CU specific for a mobile network node.

7. A network node, comprising:
at least one memory; and
at least one processor coupled with the at least one memory and configured to cause the network node to:
establish a radio resource control (RRC) connection with a first centralized unit (CU); and
set up an F1 connection with a second CU during an initial access of the network node to a network or during a migration of the network node from the first CU to the second CU.

8. The network node of claim 7, wherein the at least one processor is further configured to cause the network node to:
receive, from the first CU, an indication indicating to the network node to set up an F1 connection to a CU different from the first CU; or
transmit, to the first CU, an indication indicating that the network node determines to set up an F1 connection to a CU different from the first CU.

9. The network node of claim 7, wherein the at least one processor is further configured to cause the network node to transmit, to the second CU, an F1 setup request message, wherein the F1 setup request message includes a global ID of the network node.

10. The network node of claim 9, wherein the global ID of the network node comprises a global ID of the first CU and a backhaul adaptation protocol (BAP) address of the network node.

11. A second centralized unit (CU), comprising:
at least one memory; and
at least one processor coupled with the at least one memory and configured to cause the second CU to:
receive, from a first CU, information associated with a network node, wherein the network node has a radio resource control (RRC) connection with the first CU; and
set up an F1 connection with the network node based at least on the information associated with the network node.

12. The second CU of claim 11, wherein the information associated with the network node comprises at least one of:
internet protocol (IP) header information of a downlink (DL) message associated with the F1 connection setup to the network node;
a backhaul adaptation protocol (BAP) address of the network node;
a distributed unit (DU) ID of the network node; or
a global ID of the first CU.

13. The second CU of claim 12, wherein the IP header information of the DL message associated with the F1 connection setup to the network node comprises at least one of:
a differentiated services code point (DSCP) of the DL message;
an IPV6 flow label of the DL message; or
an IP address or a transport network layer (TNL) address of the network node.

14. The second CU of claim 11, wherein the at least one processor is further configured to cause the second CU to transmit, to the first CU or a core network entity, an indication indicating that the second CU is a mobile CU specific for a mobile network node.

15. The second CU of claim 11, wherein the at least one processor is further configured to cause the second CU to receive, from the network node, an F1 setup request message, wherein the F1 setup request message includes a global ID of the network node.

16. A method performed by a network node, comprising:
establishing a radio resource control (RRC) connection with a first centralized unit (CU); and
setting up an F1 connection with a second CU during an initial access of the network node to a network or during a migration of the network node from the first CU to the second CU.

17. The method of claim 16, further comprising:
receiving, from the first CU, an indication indicating to the network node to set up an F1 connection to a CU different from the first CU; or
transmitting, to the first CU, an indication indicating that the network node determines to set up an F1 connection to a CU different from the first CU.

18. The method of claim 16, further comprising transmitting, to the second CU, an F1 setup request message, wherein the F1 setup request message includes a global ID of the network node.

19. The method of claim 18, wherein the global ID of the network node comprises a global ID of the first CU and a backhaul adaptation protocol (BAP) address of the network node.

20. The method of claim 18, further comprising receiving, from the second CU, an F1 setup response message.
